(19) United States
(12) Patent Application Publication
(10) Pub. No.: US 2024/0137180 A1
(43) Pub. Date: Apr. 25, 2024

(54) COORDINATED RESERVATION OF SIDELINK RESOURCE POOLS FOR POSITIONING

(71) Applicant: QUALCOMM Incorporated, San Diego, CA (US)

(72) Inventors: Alexandros MANOLAKOS, Escondido, CA (US); Kianoush HOSSEINI, San Diego, CA (US); Weimin DUAN, San Diego, CA (US); Krishna Kiran MUKKAVILLI, San Diego, CA (US)

(21) Appl. No.: 18/547,834

(22) PCT Filed: Jan. 6, 2022
(86) PCT No.: PCT/US2022/011369

§ 371 Date: Aug. 24, 2023

(30) Foreign Application Priority Data
Mar. 11, 2021 (GR) 20210100148

(51) Int. Cl. H04L 5/00

(52) U.S. Cl. CPC H04L 5/0051

(57) ABSTRACT

Disclosed are techniques for wireless communication. In an aspect, a first user equipment (UE) may determine that a resource pool for positioning (RPP) from a predefined plurality of RPPs should be reserved, and transmit, to at least one other UE, a reservation message indicating reservation of a RPP from the predefined plurality of RPPs. The RPP may be reserved for use by the first UE or, if the first UE is a relay UE, for use by a remote UE served by the relay UE. The reservation message may be broadcast, groupcast, multicast, etc. In response to receiving the reservation message indicating reservation of a RPP from a predefined plurality of RPPs, the at least on other UE may modify an intended transmission to reduce interference during the reserved RPP.

### CROSS-REFERENCE TO RELATED APPLICATIONS

The present Application for Patent claims the benefit of GR Application No. 20210100148, entitled “COORDINATED RESERVATION OF SIDELINK RESOURCE POOLS FOR POSITIONING”, filed Mar. 11, 2021, and is a national stage application, filed under 35 U.S.C. § 371, of International Patent Application No. PCT/US2022/011369, entitled, “COORDINATED RESERVATION OF SIDELINK RESOURCE POOLS FOR POSITIONING”, filed Jan. 6, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

Disclosed are techniques for coordinated reservation of sidelink (SL) resource pools for positioning (RPPs). In an aspect, a first user equipment (UE) may determine that a RPP from a predefined plurality of RPPs should be reserved, and transmit, to at least one other UE, a reservation message indicating reservation of a RPP from the predefined plurality of RPPs. The RPP may be reserved for use by the first UE or, if the first UE is a relay UE, for use by a remote UE served by the relay UE. The reservation message may be broadcast, groupcast, multicast, etc. In response to receiving the reservation message indicating reservation of a RPP from a predefined plurality of RPPs, the at least on other UE may modify an intended transmission to reduce interference during the reserved RPP.

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a UE includes determining that a RPP from a predefined plurality of RPPs should be reserved; and transmitting, to at least one other UE, a reservation message indicating reservation of a RPP from the predefined plurality of RPPs.

In an aspect, a method of wireless communication performed by a UE includes receiving a reservation message indicating reservation of a RPP from a predefined plurality of RPPs for use by a second UE; and modifying an intended transmission to reduce interference with the second UE during the reserved RPP.

In an aspect, a UE includes a memory; at least one transceiver; and at least one processor communicatively coupled to the memory and the at least one transceiver, the at least one processor configured to: determine that a RPP from a predefined plurality of RPPs should be reserved; and cause the at least one transceiver to transmit, to at least one other UE, a reservation message indicating a reservation of a RPP from the predefined plurality of RPPs.

In an aspect, a UE includes a memory; at least one transceiver; and at least one processor communicatively coupled to the memory and the at least one transceiver, the at least one processor configured to: receive a reservation message indicating reservation of a RPP from a predefined plurality of RPPs for use by a second UE; and modify an intended transmission to reduce interference with the second UE during the reserved RPP.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIG. 3 illustrates an example of a wireless communications system that supports unicast sidelink establishment, according to aspects of the disclosure.

FIG. 4 illustrates time and frequency resources used for sidelink communication.

FIGS. 5A to 5C are simplified block diagrams of several sample aspects of components that may be employed in a user equipment (UE), a base station, and a network entity, respectively, and configured to support communications as taught herein.

FIGS. 6A and 6B illustrate two methods for single-cell UE positioning that can be implemented if the cell includes multiple UEs that are engaged in SL communications.

FIG. 7 illustrates a conventional sidelink positioning scenario involving a relay UE that serves multiple remote UEs without involvement of a base station.

FIG. 8 illustrates some of the technical disadvantages suffered by the conventional methods.

FIGS. 9-11 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-cNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference RF signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

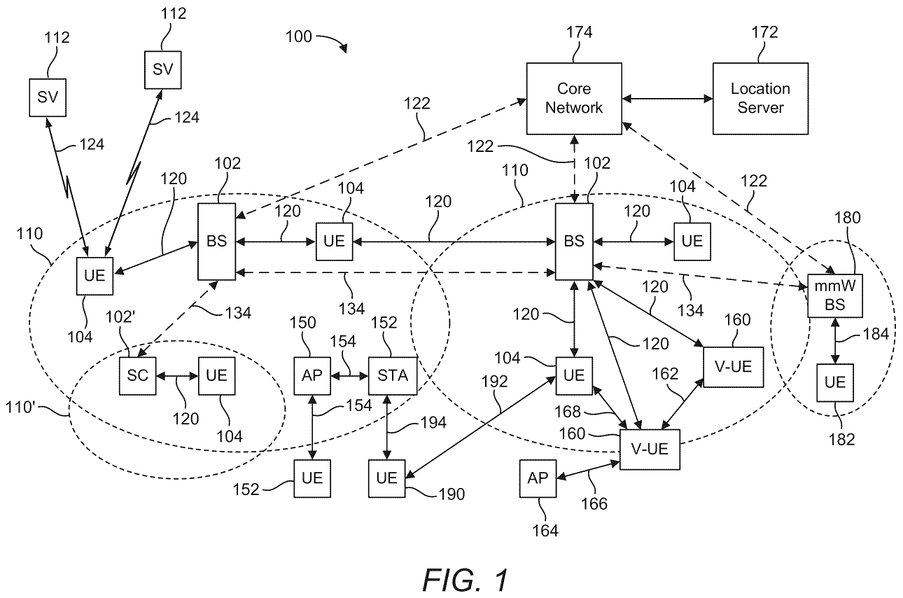

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-cNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 174 (e.g., an evolved packet core (EPC) or 5G core (5GC)) through backhaul links 122, and through the core network 174 to one or more location servers 172 (e.g., a location management function (LMF) or a secure user plane location (SUPL) location platform (SLP)). The location server(s) 172 may be part of core network 174 or may be external to core network 174. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). mmW frequency bands generally include the FR2. FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, one or more Earth orbiting satellite positioning system (SPS) space vehicles (SVs) 112 (e.g., satellites) may be used as an independent source of location information for any of the illustrated UEs (shown in FIG. 1 as a single UE 104 for simplicity). A UE 104 may include one or more dedicated SPS receivers specifically designed to receive SPS signals 124 for deriving geo location information from the SVs 112. An SPS typically includes a system of transmitters (e.g., SVs 12) positioned to enable receivers (e.g., UEs 104) to determine their location on or above the Earth based, at least in part, on signals (e.g., SPS signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104.

The use of SPS signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals 124 may include SPS. SPS-like, and/or other signals associated with such one or more SPS.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 (e.g., using the Uu interface). V-UEs 160 may also communicate directly with each other over a wireless sidelink 162, with a roadside access point 164 (also referred to as a “roadside unit”) over a wireless sidelink 166, or with UEs 104 over a wireless sidelink 168. A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for D2D media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a movement entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more roadside access points 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more roadside access points 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards roadside access points 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

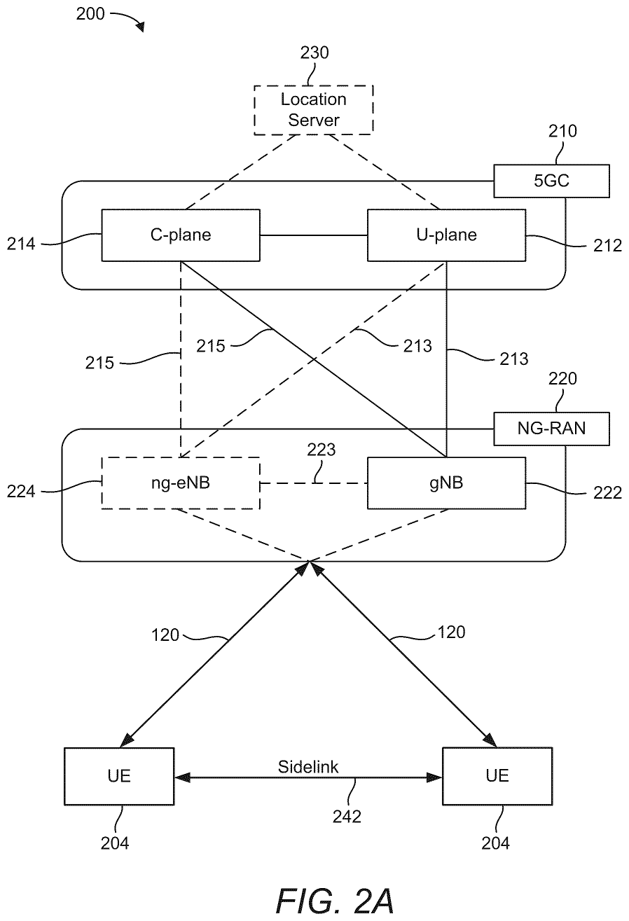

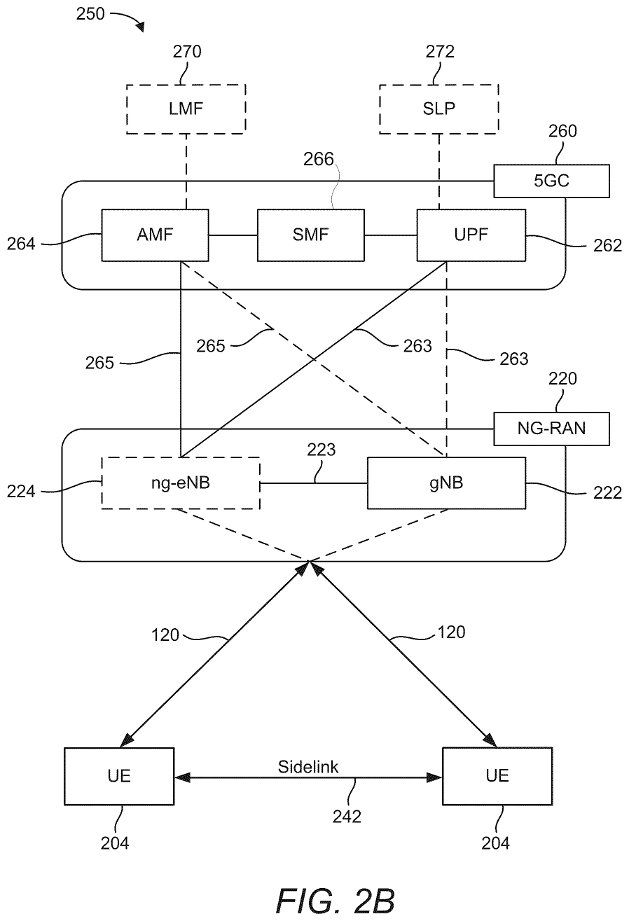

FIG. 2A illustrates an example wireless network structure 200. For example, a 5GC 210 (also referred to as a Next Generation Core (NGC)) can be viewed functionally as control plane functions (C-plane) 214 (e.g., UE registration, authentication, network access, gateway selection, etc.) and user plane functions (U-plane) 212 (e.g., UE gateway function, access to data networks, IP routing, etc.), which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may only have one or more gNBs 222, while other configurations include one or more of both ng-eNBs 224 and gNBs 222. Either (or both) gNB 222 or ng-eNB 224 may communicate with UEs 204 (e.g., any of the UEs described herein). In an aspect, two or more UEs 204 may communicate with each other over a wireless sidelink 242, which may correspond to wireless sidelink 162 in FIG. 1.

Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network.

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the NG-RAN 220 may only have one or more gNBs 222, while other configurations include one or more of both ng-eNBs 224 and gNBs 222. The base stations of the NG-RAN 220 communicate with the AMF 264 over the N2 interface and with the UPF 262 over the N3 interface. Either (or both) gNB 222 or ng-eNB 224 may communicate with UEs 204 (e.g., any of the UEs described herein). In an aspect, two or more UEs 204 may communicate with each other over a sidelink 242, which may correspond to sidelink 162 in FIG. 1.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and an LMF 270 which acts as a location server 230, transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270 but, whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g. using protocols intended to carry voice and/or data like the transmission control protocol (TCP) and/or IP).

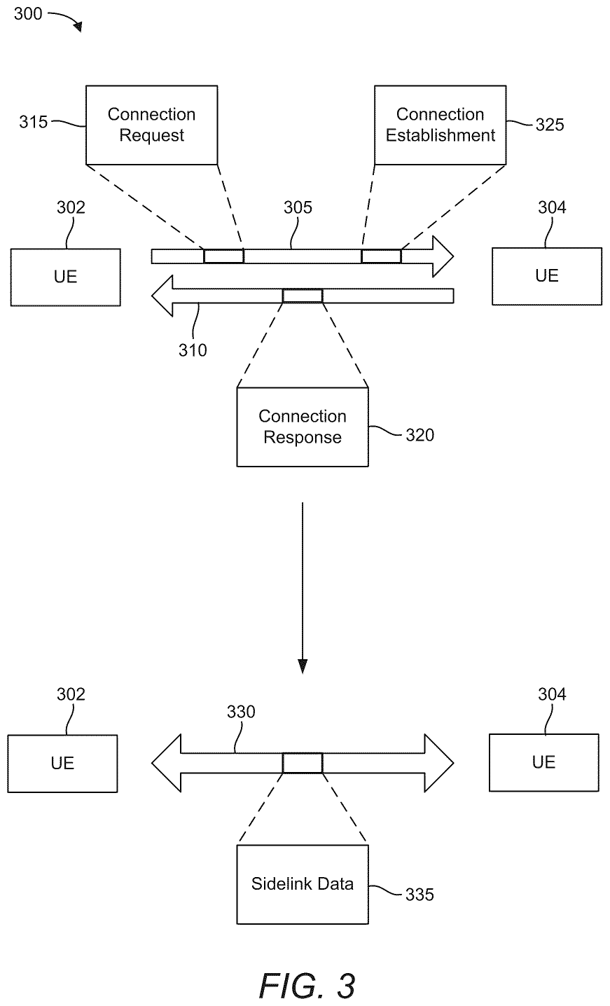

FIG. 3 illustrates an example of a wireless communications system 300 that supports wireless unicast sidelink establishment, according to aspects of the disclosure. In some examples, wireless communications system 300 may implement aspects of wireless communications systems 100, 200, and 250. Wireless communications system 300 may include a first UE 302 and a second UE 304, which may be examples of any of the UEs described herein. As specific examples, UEs 302 and 304 may correspond to V-UEs 160 in FIG. 1, UE 190 and UE 104 in FIG. 1 connected over sidelink 192, or UEs 204 in FIGS. 2A and 2B.

In the example of FIG. 3, the UE 302 may attempt to establish a unicast connection over a sidelink with the UE 304, which may be a V2X sidelink between the UE 302 and UE 304. As specific examples, the established sidelink connection may correspond to sidelinks 162 and/or 168 in FIG. 1 or sidelink 242 in FIGS. 2A and 2B. The sidelink connection may be established in an omni-directional frequency range (e.g., FR1) and/or a mmW frequency range (e.g., FR2). In some cases, the UE 302 may be referred to as an initiating UE that initiates the sidelink connection procedure, and the UE 304 may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 302 and UE 304. For example, a transmission and reception capability matching may be negotiated between the UE 302 and UE 304. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 302 and UE 304. Additionally, a security association may be established between UE 302 and UE 304 for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally, IP configurations (e.g., IP versions, addresses, etc.) may be negotiated for the unicast connection between UE 302 and UE 304.

In some cases, UE 304 may create a service announcement (e.g., a service capability message) to transmit over a cellular network (e.g., cV2X) to assist the sidelink connection establishment. Conventionally, UE 302 may identify and locate candidates for sidelink communications based on a basic service message (BSM) broadcasted unencrypted by nearby UEs (e.g., UE 304). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 302 is able to detect the BSM(s). Accordingly, the service announcement transmitted by UE 304 and other nearby UEs (e.g., a discovery signal) may be an upper layer signal and broadcasted (e.g., in an NR sidelink broadcast). In some cases, the UE 304 may include one or more parameters for itself in the service announcement, including connection parameters and/or capabilities it possesses. The UE 302 may then monitor for and receive the broadcasted service announcement to identify potential UEs for corresponding sidelink connections. In some cases, the UE 302 may identify the potential UEs based on the capabilities each UE indicates in their respective service announcements.

The service announcement may include information to assist the UE 302 (e.g., or any initiating UE) to identify the UE transmitting the service announcement (UE 304 in the example of FIG. 3). For example, the service announcement may include channel information where direct communication requests may be sent. In some cases, the channel information may be RAT-specific (e.g., specific to LTE or NR) and may include a resource pool within which UE 302 transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 302 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally generated random protocol. Additionally, the service announcement may include a type of protocol for credential establishment and QoS-related parameters.

After identifying a potential sidelink connection target (UE 304 in the example of FIG. 3), the initiating UE (UE 302 in the example of FIG. 3) may transmit a connection request 315 to the identified target UE 304. In some cases, the connection request 315 may be a first RRC message transmitted by the UE 302 to request a unicast connection with the UE 304 (e.g., an “RRCDirectConnectionSetupRequest” message). For example, the unicast connection may utilize the PC5 interface for the sidelink, and the connection request 315 may be an RRC connection setup request message. Additionally, the UE 302 may use a sidelink signaling radio bearer 305 to transport the connection request 315.

After receiving the connection request 315, the UE 304 may determine whether to accept or reject the connection request 315. The UE 304 may base this determination on a transmission/reception capability, an ability to accommodate the unicast connection over the sidelink, a particular service indicated for the unicast connection, the contents to be transmitted over the unicast connection, or a combination thereof. For example, if the UE 302 wants to use a first RAT to transmit or receive data, but the UE 304 does not support the first RAT, then the UE 304 may reject the connection request 315. Additionally or alternatively, the UE 304 may reject the connection request 315 based on being unable to accommodate the unicast connection over the sidelink due to limited radio resources, a scheduling issue, etc. Accordingly, the UE 304 may transmit an indication of whether the request is accepted or rejected in a connection response 320. Similar to the UE 302 and the connection request 315, the UE 304 may use a sidelink signaling radio bearer 310 to transport the connection response 320. Additionally, the connection response 320 may be a second RRC message transmitted by the UE 304 in response to the connection request 315 (e.g., an “RRCDirectConnectionResponse” message).

In some cases, sidelink signaling radio bearers 305 and 310 may be the same sidelink signaling radio bearer or may be separate sidelink signaling radio bearers. Accordingly, a radio link control (RLC) layer acknowledged mode (AM) may be used for sidelink signaling radio bearers 305 and 310. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 320 indicates that the UE 304 accepted the connection request 315, the UE 302 may then transmit a connection establishment 325 message on the sidelink signaling radio bearer 305 to indicate that the unicast connection setup is complete. In some cases, the connection establishment 325 may be a third RRC message (e.g., an “RRCDirectConnectionSetupComplete” message). Each of the connection request 315, the connection response 320, and the connection establishment 325 may use a basic capability when being transported from one UE to the other UE to enable each UE to be able to receive and decode the corresponding transmission (e.g., the RRC messages).

Additionally, identifiers may be used for each of the connection request 315, the connection response 320, and the connection establishment 325. For example, the identifiers may indicate which UE 302/304 is transmitting which message and/or for which UE 302/304 the message is intended. For physical (PHY) layer channels, the RRC signaling and any subsequent data transmissions may use the same identifier (e.g., Layer 2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 315 and/or the connection response 320 for UE 302 and/or UE 304, respectively, to enable negotiation of corresponding AS layer parameters for the unicast connection. For example, the UE 302 and/or UE 304 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 302 and/or UE 304 may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 302 and/or UE 304 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, carrier aggregation, or a combination thereof for the unicast connection. Additionally, the UE 302 and/or UE 304 may include PHY layer parameters when establishing the unicast connection to set a PHY layer context for the unicast connection. For example, the PHY layer context may indicate a transmission format (unless transmission profiles are included for each UE 302/304) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 325 message is transmitted). Before a security association (e.g., security context) is established between the UE 302 and UE 304, the sidelink signaling radio bearers 305 and 310 may not be protected. After a security association is established, the sidelink signaling radio bearers 305 and 310 may be protected. Accordingly, the security context may enable secure data transmissions over the unicast connection and the sidelink signaling radio bearers 305 and 310. Additionally, IP layer parameters (e.g., link local IPv4 or IPv6 addresses) may also be negotiated. In some cases, the IP layer parameters may be negotiated by an upper layer control protocol running after RRC signaling is established (e.g., the unicast connection is established). As noted above, the UE 304 may base its decision on whether to accept or reject the connection request 315 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 302 and UE 304 may communicate using the unicast connection over a sidelink 330, where sidelink data 335 is transmitted between the two UEs 302 and 304. The sidelink 330 may correspond to sidelinks 162 and/or 168 in FIG. 1 and/or sidelink 242 in FIGS. 2A and 2B. In some cases, the sidelink data 335 may include RRC messages transmitted between the two UEs 302 and 304. To maintain this unicast connection on sidelink 330, UE 302 and/or UE 304 may transmit a keep alive message (e.g., “RRCDirectLinkAlive” message, a fourth RRC message, etc.). In some cases, the keep alive message may be triggered periodically or on-demand (e.g., event-triggered). Accordingly, the triggering and transmission of the keep alive message may be invoked by UE 302 or by both UE 302 and UE 304. Additionally or alternatively, a MAC control element (CE) (e.g., defined over sidelink 330) may be used to monitor the status of the unicast connection on sidelink 330 and maintain the connection. When the unicast connection is no longer needed (e.g., UE 302 travels far enough away from UE 304), either UE 302 and/or UE 304 may start a release procedure to drop the unicast connection over sidelink 330. Accordingly, subsequent RRC messages may not be transmitted between UE 302 and UE 304 on the unicast connection.

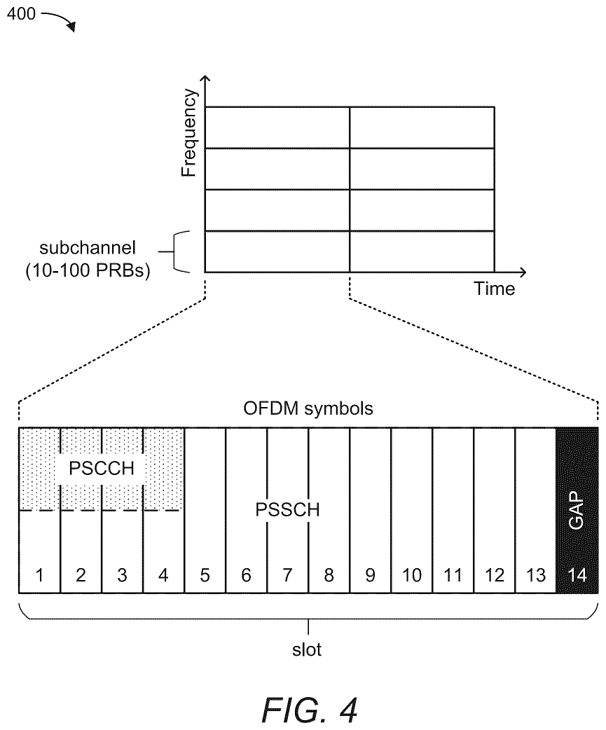

FIG. 4 illustrates time and frequency resources used for sidelink communication. A time-frequency grid 400 is divided into subchannels in the frequency domain and is divided into time slots in the time domain. Each subchannel comprises a number (e.g., 10, 15, 20, 25, 50, 75, or 100) of physical resource blocks (PRBs), and each slot contains a number (e.g., 14) of OFDM symbols. A sidelink communication can be (pre)configured to occupy fewer than 14 symbols in a slot. The first symbol of the slot is repeated on the preceding symbol for automatic gain control (AGC) settling. The example slot shown in FIG. 4 contains a physical sidelink control channel (PSCCH) portion and a physical sidelink shared channel (PSSCH) portion, with a gap symbol following the PSCCH. PSCCH and PSSCH are transmitted in the same slot.

Sidelink communications take place within transmission or reception resource pools. Sidelink communications occupy one slot and one or more subchannels. Some slots are not available for sidelink, and some slots contain feedback resources. Sidelink communication can be preconfigured (e.g., preloaded on a UE) or configured (e.g., by a base station via RRC).

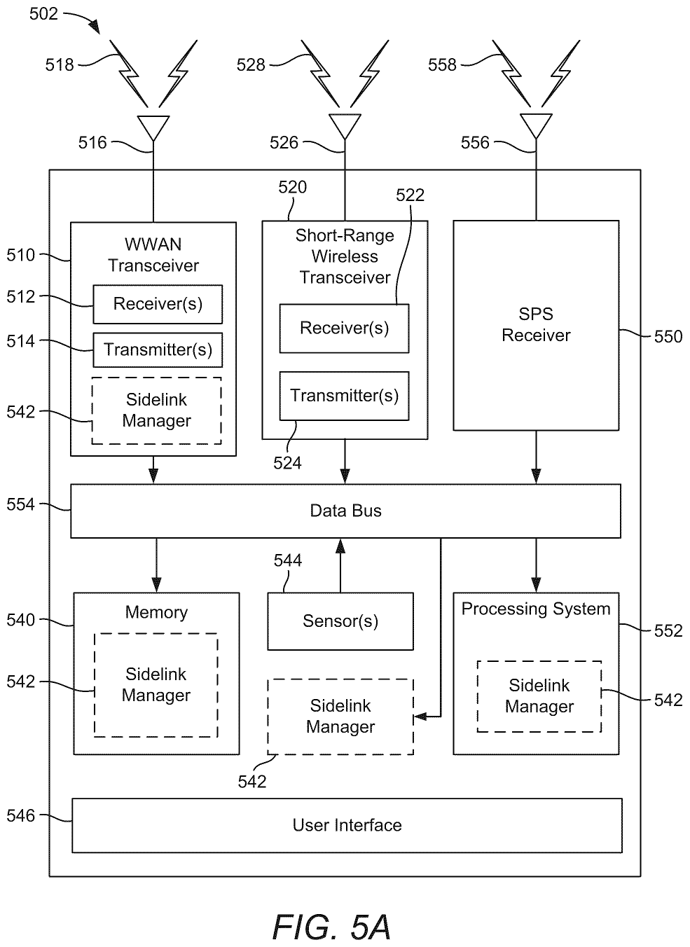

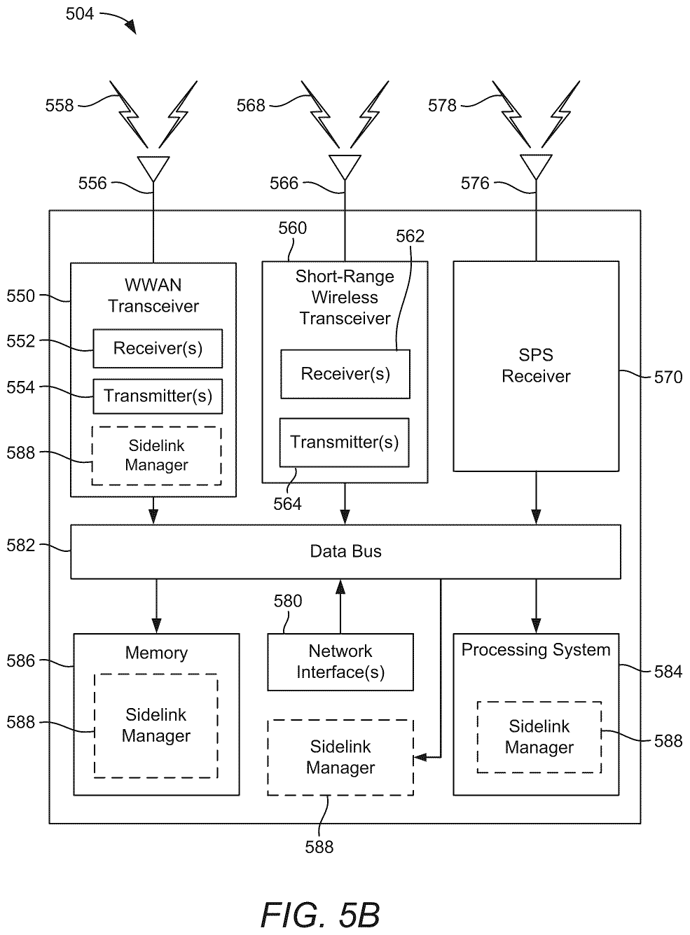

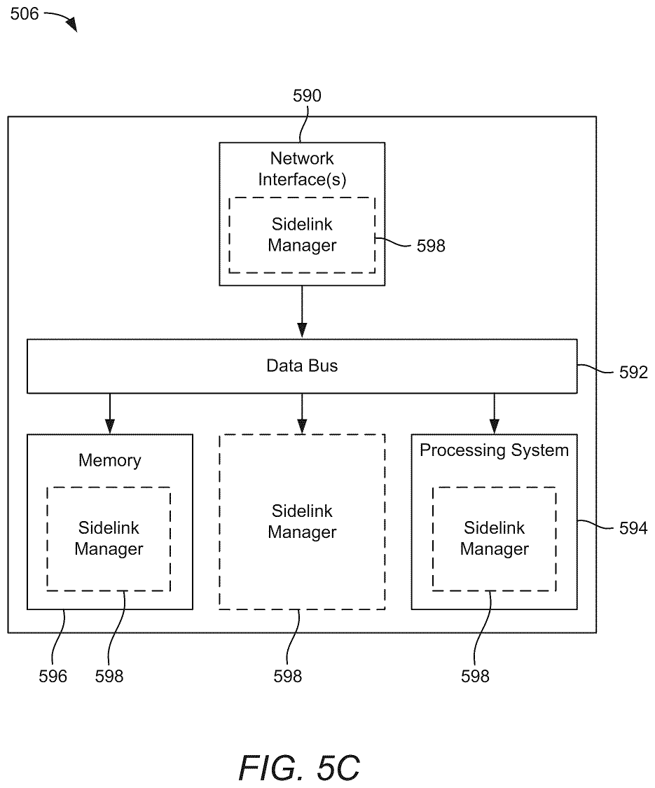

FIGS. 5A, 5B, and 5C illustrate several example components (represented by corresponding blocks) that may be incorporated into a UE 502 (which may correspond to any of the UEs described herein, including the V-UE 160 in FIG. 1), a base station 504 (which may correspond to any of the base stations described herein), and a network entity 506 (which may correspond to or embody any of the network functions described herein, including the location server 230 and the LMF 270) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 502 and the base station 504 each include wireless wide area network (WWAN) transceiver 510 and 550, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 510 and 550 may be connected to one or more antennas 516 and 556, respectively, for communicating with other network nodes, such as other UEs, access points, base stations (e.g., eNBs, gNBs), etc., via at least one designated RAT (e.g., NR. LTE, GSM, etc.) over a wireless communication medium of interest (e.g., some set of time/frequency resources in a particular frequency spectrum). The WWAN transceivers 510 and 550 may be variously configured for transmitting and encoding signals 518 and 558 (e.g., messages, indications, information, and so on), respectively, and, conversely, for receiving and decoding signals 518 and 558 (e.g., messages, indications, information, pilots, and so on), respectively, in accordance with the designated RAT. Specifically, the WWAN transceivers 510 and 550 include one or more transmitters 514 and 554, respectively, for transmitting and encoding signals 518 and 558, respectively, and one or more receivers 512 and 552, respectively, for receiving and decoding signals 518 and 558, respectively.

The UE 502 and the base station 504 also include, at least in some cases, one or more short-range wireless transceivers 520 and 560, respectively. The short-range wireless transceivers 520 and 560 may be connected to one or more antennas 526 and 566, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wavc®, PC5, dedicated short-range communications (DSRC), wireless access for vehicular environments (WAVE), near-field communication (NFC), etc.) over a wireless communication medium of interest. The short-range wireless transceivers 520 and 560 may be variously configured for transmitting and encoding signals 528 and 568 (e.g., messages, indications, information, and so on), respectively, and, conversely, for receiving and decoding signals 528 and 568 (e.g., messages, indications, information, pilots, and so on), respectively, in accordance with the designated RAT. Specifically, the short-range wireless transceivers 520 and 560 include one or more transmitters 524 and 564, respectively, for transmitting and encoding signals 528 and 568, respectively, and one or more receivers 522 and 562, respectively, for receiving and decoding signals 528 and 568, respectively. As specific examples, the short-range wireless transceivers 520 and 560 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 516, 526, 556, 566), such as an antenna array, that permits the respective apparatus to perform transmit “beamforming,” as described herein. Similarly, a receiver may include or be coupled to a plurality of antennas (e.g., antennas 516, 526, 556, 566), such as an antenna array, that permits the respective apparatus to perform receive beamforming, as described herein. In an aspect, the transmitter and receiver may share the same plurality of antennas (e.g., antennas 516, 526, 556, 566), such that the respective apparatus can only receive or transmit at a given time, not both at the same time. A wireless communication device (e.g., one or both of the transceivers 510 and 520 and/or 550 and 560) of the UE 502 and/or the base station 504 may also comprise a network listen module (NLM) or the like for performing various measurements.

The UE 502 and the base station 504 also include, at least in some cases, satellite positioning systems (SPS) receivers 530 and 570. The SPS receivers 530 and 570 may be connected to one or more antennas 536 and 576, respectively, and may provide means for receiving and/or measuring SPS signals 538 and 578, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 530 and 570 may comprise any suitable hardware and/or software for receiving and processing SPS signals 538 and 578, respectively. The SPS receivers 530 and 570 request information and operations as appropriate from the other systems and perform calculations necessary to determine positions of the UE 502 and the base station 504 using measurements obtained by any suitable SPS algorithm.

The base station 504 and the network entity 506 each include at least one network interfaces 580 and 590, respectively, providing means for communicating (e.g., means for transmitting, means for receiving, etc.) with other network entities. For example, the network interfaces 580 and 590 (e.g., one or more network access ports) may be configured to communicate with one or more network entities via a wire-based or wireless backhaul connection. In some aspects, the network interfaces 580 and 590 may be implemented as transceivers configured to support wire-based or wireless signal communication. This communication may involve, for example, sending and receiving messages, parameters, and/or other types of information.

In an aspect, the WWAN transceiver 510 and/or the short-range wireless transceiver 520 may form a (wireless) communication interface of the UE 502. Similarly, the WWAN transceiver 550, the short-range wireless transceiver 560, and/or the network interface(s) 580 may form a (wireless) communication interface of the base station 504. Likewise, the network interface(s) 590 may form a (wireless) communication interface of the network entity 506.

The UE 502, the base station 504, and the network entity 506 also include other components that may be used in conjunction with the operations as disclosed herein. The UE 502 includes processor circuitry implementing a processing system 532 for providing functionality relating to, for example, wireless positioning, and for providing other processing functionality. The base station 504 includes a processing system 584 for providing functionality relating to, for example, wireless positioning as disclosed herein, and for providing other processing functionality. The network entity 506 includes a processing system 594 for providing functionality relating to, for example, wireless positioning as disclosed herein, and for providing other processing functionality. The processing systems 532, 584, and 594 may therefore provide means for processing, such as means for determining, means for calculating, means for receiving, means for transmitting, means for indicating, etc. In an aspect, the processing systems 532, 584, and 594 may include, for example, one or more processors, such as one or more general purpose processors, multi-core processors, ASICs, digital signal processors (DSPs), field programmable gate arrays (FPGA), other programmable logic devices or processing circuitry, or various combinations thereof.

The UE 502, the base station 504, and the network entity 506 include memory circuitry implementing memory components 540, 586, and 596 (e.g., each including a memory device), respectively, for maintaining information (e.g., information indicative of reserved resources, thresholds, parameters, and so on). The memory components 540, 586, and 596 may therefore provide means for storing, means for retrieving, means for maintaining, etc. In some cases, the UE 502, the base station 504, and the network entity 506 may include sidelink managers 542, 588, and 598, respectively. The sidelink managers 542, 588, and 598 may be hardware circuits that are part of or coupled to the processing systems 532, 584, and 594, respectively, that, when executed, cause the UE 502, the base station 504, and the network entity 506 to perform the functionality described herein. In other aspects, the sidelink managers 542, 588, and 598 may be external to the processing systems 532, 584, and 594 (e.g., part of a modem processing system, integrated with another processing system, etc.). Alternatively, the sidelink managers 542, 588, and 598 may be memory modules stored in the memory components 540, 586, and 596, respectively, that, when executed by the processing systems 532, 584, and 594 (or a modem processing system, another processing system, etc.), cause the UE 502, the base station 504, and the network entity 506 to perform the functionality described herein. FIG. 5A illustrates possible locations of the sidelink manager 542, which may be part of the WWAN transceiver 510, the memory component 540, the processing system 532, or any combination thereof, or may be a standalone component. FIG. 5B illustrates possible locations of the sidelink manager 588, which may be part of the WWAN transceiver 550, the memory component 586, the processing system 584, or any combination thereof, or may be a standalone component. FIG. 5C illustrates possible locations of the sidelink manager 598, which may be part of the network interface(s) 590, the memory component 596, the processing system 594, or any combination thereof, or may be a standalone component.

The UE 502 may include one or more sensors 544 coupled to the processing system 532 to provide means for sensing or detecting movement and/or orientation information that is independent of motion data derived from signals received by the WWAN transceiver 510, the short-range wireless transceiver 520, and/or the SPS receiver 530. By way of example, the sensor(s) 544 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 544 may include a plurality of different types of devices and combine their outputs in order to provide motion information. For example, the sensor(s) 544 may use a combination of a multi-axis accelerometer and orientation sensors to provide the ability to compute positions in 2D and/or 3D coordinate systems.

In addition, the UE 502 includes a user interface 546 providing means for providing indications (e.g., audible and/or visual indications) to a user and/or for receiving user input (e.g., upon user actuation of a sensing device such a keypad, a touch screen, a microphone, and so on). Although not shown, the base station 504 and the network entity 506 may also include user interfaces.

Referring to the processing system 584 in more detail, in the downlink, IP packets from the network entity 506 may be provided to the processing system 584. The processing system 584 may implement functionality for an RRC layer, a packet data convergence protocol (PDCP) layer, a radio link control (RLC) layer, and a medium access control (MAC) layer. The processing system 584 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 554 and the receiver 552 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 554 handles mapping to signal constellations based on various modulation schemes (e.g., binary phase-shift keying (BPSK), quadrature phase-shift keying (QPSK). M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 502. Each spatial stream may then be provided to one or more different antennas 556. The transmitter 554 may modulate an RF carrier with a respective spatial stream for transmission.

At the UE 502, the receiver 512 receives a signal through its respective antenna(s) 516. The receiver 512 recovers information modulated onto an RF carrier and provides the information to the processing system 532. The transmitter 514 and the receiver 512 implement Layer-1 functionality associated with various signal processing functions. The receiver 512 may perform spatial processing on the information to recover any spatial streams destined for the UE 502. If multiple spatial streams are destined for the UE 502, they may be combined by the receiver 512 into a single OFDM symbol stream. The receiver 512 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 504. These soft decisions may be based on channel estimates computed by a channel estimator. The soft decisions are then decoded and de-interleaved to recover the data and control signals that were originally transmitted by the base station 504 on the physical channel. The data and control signals are then provided to the processing system 532, which implements Layer-3 (L3) and Layer-2 (L2) functionality.

In the uplink, the processing system 532 provides demultiplexing between transport and logical channels, packet reassembly, deciphering, header decompression, and control signal processing to recover IP packets from the core network. The processing system 532 is also responsible for error detection.

Similar to the functionality described in connection with the downlink transmission by the base station 504, the processing system 532 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 504 may be used by the transmitter 514 to select the appropriate coding and modulation schemes, and to facilitate spatial processing. The spatial streams generated by the transmitter 514 may be provided to different antenna(s) 516. The transmitter 514 may modulate an RF carrier with a respective spatial stream for transmission.

The uplink transmission is processed at the base station 504 in a manner similar to that described in connection with the receiver function at the UE 502. The receiver 552 receives a signal through its respective antenna(s) 556. The receiver 552 recovers information modulated onto an RF carrier and provides the information to the processing system 584.

In the uplink, the processing system 584 provides demultiplexing between transport and logical channels, packet reassembly, deciphering, header decompression, control signal processing to recover IP packets from the UE 502. IP packets from the processing system 584 may be provided to the core network. The processing system 584 is also responsible for error detection.

For convenience, the UE 502, the base station 504, and/or the network entity 506 are shown in FIGS. 5A to 5C as including various components that may be configured according to the various examples described herein. It will be appreciated, however, that the illustrated blocks may have different functionality in different designs.

The various components of the UE 502, the base station 504, and the network entity 506 may communicate with each other over data buses 534, 582, and 592, respectively. In an aspect, the data buses 534, 582, and 592 may form, or be part of, the communication interface of the UE 502, the base station 504, and the network entity 506, respectively. For example, where different logical entities are embodied in the same device (e.g., gNB and location server functionality incorporated into the same base station 504), the data buses 534, 582, and 592 may provide communication between them.

The components of FIGS. 5A to 5C may be implemented in various ways. In some implementations, the components of FIGS. 5A to 5C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 510 to 546 may be implemented by processor and memory component(s) of the UE 502 (e.g., by execution of appropriate code and/or by appropriate configuration of processor components). Similarly, some or all of the functionality represented by blocks 550 to 588 may be implemented by processor and memory component(s) of the base station 504 (e.g., by execution of appropriate code and/or by appropriate configuration of processor components). Also, some or all of the functionality represented by blocks 590 to 598 may be implemented by processor and memory component(s) of the network entity 506 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 502, base station 504, network entity 506, etc., such as the processing systems 532, 584, 594, the transceivers 510, 520, 550, and 560, the memory components 540, 586, and 596, the sidelink managers 542, 588, and 598, etc.

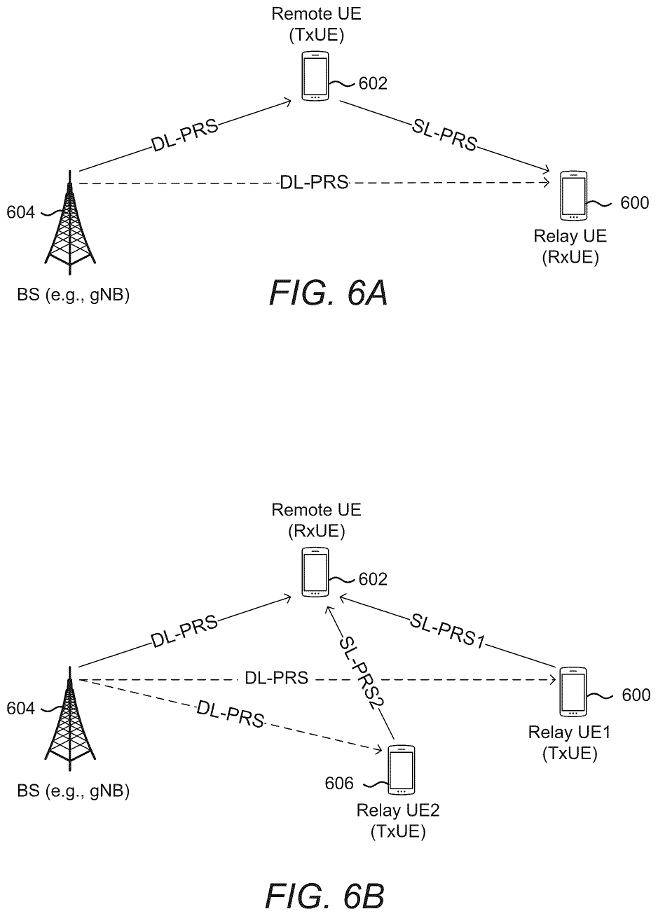

FIGS. 6A and 6B illustrate two methods for single-cell UE positioning that can be implemented if the cell includes multiple UEs that are engaged in SL communications. In FIGS. 6A and 6B, a UE that transmits a SL-PRS may be referred to as a “TxUE” and a UE that receives a SL-PRS may be referred to as an “RxUE”. The methods illustrated FIGS. 6A and 6B have the technical benefit that they do not require any uplink transmissions, which can save power.

In FIG. 6A, a relay UE 600 (with a known location) participates in the positioning estimation of a remote UE 602 without having to perform any UL PRS transmission to a base station 604 (e.g., a gNB). As shown in FIG. 6A, the remote UE 602 receives a DL-PRS from the BS 604, and transmits an SL-PRS to the relay UE 600. This SL-PRS transmission can be low power because the SL-PRS transmission from the remote UE 602 does not need to reach the BS 604, but only needs to reach the nearby relay UE 600.

In FIG. 6B, multiple relay UEs, including relay UE 600 acting as a first relay UE and relay UE 606 acting as a second relay UE, transmit SL-PRS signals (SL-PRS1 and SL-PRS2, respectively) to the remote UE 602. In contrast to the method shown in FIG. 6A, where the remote UE 602 was the TxUE and the relay UE 600 was the RxUE, in FIG. 6B, those roles are reversed, with the relay UE 600 and the relay UE 606 being TxUEs and the remote UE 602 being the RxUE. In this scenario also, the SL-PRS signals transmitted by the TxUEs can be low power, and no UL communication is required.

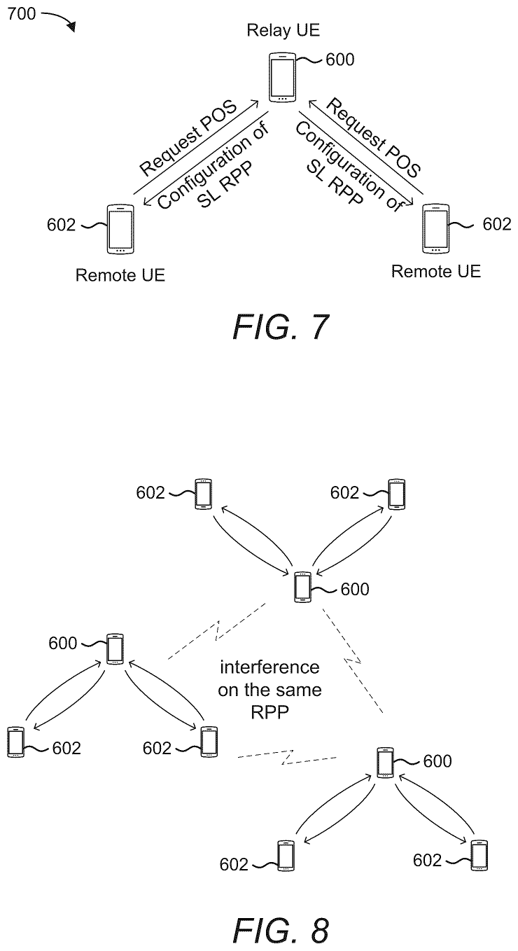

FIG. 7 illustrates a conventional sidelink positioning scenario 700 involving a relay UE 600 that serves multiple remote UEs 602 without involvement of a base station. The relay UE 600 and remote UEs 602 have been (pre)configured with a set of resource pools for positioning (RPP). In this scenario, each remote UE 602 can transmit a positioning request to the relay UE 600, and the relay UE 600 may respond to the respective positioning request by sending the remote UE 602 a configuration message that assigns an RPP to the respective remote UE 602 for use by that remote UE. The position request may specify a particular RPP that the requesting remote UE 704 wants to use, or it may be a general request for any available RPP, in which case the relay UE 600 will select an RPP from the set of RPPs. The configuration message may assign the RPP requested (if one was requested) or the relay UE 600 may choose another RPP from the set of RPPs.

FIG. 8 illustrates some of the technical disadvantages suffered by the conventional method shown in FIG. 7. In FIG. 8, multiple relay UEs 600 and their corresponding remote UEs 602 are in proximity to each other, and each relay UE 600 may be assigning an RPP to one of its remote UEs 602 without consideration of what neighboring relay UEs 600 are assigning to their respective remote UEs 602. As a result, it is possible that two remote UEs 602 are attempting to use the same RPP at the same time and thus interfere with each other. Current standards define no mechanism by which such interference can be proactively avoided. To address these technical disadvantages, techniques for coordinated reservation of SL RPPs are presented.

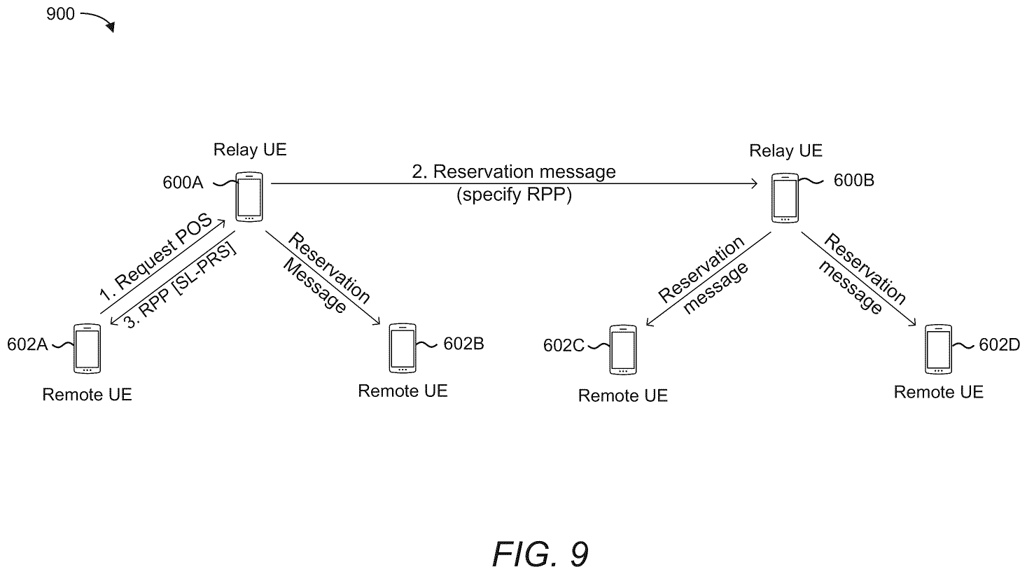

FIG. 9 illustrates a method 900 for coordinated reservation of SL RPPs according to aspects of the disclosure. In FIG. 9, a first relay UE 600A is serving remote UE 602A and remote UE 602B, and a second relay UE 600B is serving remote UE 602C and remote UE 602D. The number of relay UEs and the number of remote UEs that each relay UE serves can vary, these numbers are illustrative and not limiting. Each of the UEs is configured with a predefined set of RPPs. The predefined plurality of RPPs may be preloaded on the UE or configured by a serving base station, e.g., via RCC.

In method 900, a UE determines that a RPP from the predefined plurality of RPPs should be reserved. In the example shown in FIG. 9, the relay UE 600 receives, from a remote UE 602A, a request for a RPP from the predefined plurality of RPPs. The remote UE 602A may issue a general request for any available RPP, in which case the relay UE 600 may select one of the RPPs from the predefined set of RPPs. Alternatively, the remote UE 602A may request a specific RPP, in which case the relay UE 600 may select that specific RPP, or the relay UE 600 may select a different RPP, e.g., such as when the requested RPP is unavailable due to being reserved by another remote UE or for some other reason.

In response, relay UE 600A transmits a reservation message for reserving a specified RPP. The reservation message may be transmitted via a broadcast, groupcast, or multicast message. The reservation message may be transmitted via a physical sidelink control channel (PSCCH), a physical sidelink shared channel (PSSCH), or a combination thereof. In one aspect, the reservation message is transmitted to the remote UE 602B and to the relay UE 600B, and the relay UE 600B relays the message to the remote UE 602C and remote UE 602D. Alternatively, the reservation message is transmitted to the relay UE 600B, the remote UE 602B, the remote UE 602C, and the remote UE 602D simultaneously. Alternatively, the relay UE 600A may send a set of unicast messages to neighboring UEs.

The reservation message may include additional information, such as, but not limited to, the following. The reservation message may indicate that a sidelink positioning reference signal (SL-PRS) will be transmitted using the reserved RPP. The reservation message may specify particular SL-PRS resources within the RPP that will be used. The reservation message may identify the remote UE that will use the reserved RPP. The reservation message may include an RPP identifier. The reservation message may include a zone identifier that specifies the geographic zone or zones to which the reservation applies.

The reservation message may include a priority indication that specifies the relative priority of a positioning operation to other types of operations that might also use the resources of the RPP. For example, if the priority of the positioning operation is higher than the priority of a data or reference signal transmission by a neighboring UE, then the neighboring UEs are expected to avoid scheduling; otherwise, the neighboring UEs can schedule also.

The reservation request may include or imply a request that the UEs receiving the reservation request (and that are within the specified zone, if applicable) reduce interference during the reserved RPP, e.g., by rate-matching, muting, puncturing, reducing transmit power, or combinations thereof, during the reserved RPP, and, if applicable, within the specified SL-PRS resources. In the example shown in FIG. 9, the relay UE 600B, the remote UE 602B, the remote UE 602C, and the remote UE 602D may respond to the reservation request, e.g., by modifying an intended transmission to reduce interference with the remote UE 602B during the reserved RPP.

In some aspects, the reservation message may include timing information associated with the reservation, such as, but not limited to, the timing information associated with the reservation comprises a start time of the RPP, a stop time of the RPP, a time offset of the RPP, a periodicity of the RPP, an indicator that the RPP does not repeat (e.g., that this is a single-shot request), or combinations thereof.

In FIG. 9, the relay UE 600A then sends a configuration message to remote UE 602A. The configuration message identifies the RPP to be used by remote UE 602A and may also specify a subset of SL-PRS resources within the RPP to be used by remote UE 602A. In some aspects, the SL-PRS resources within the reserved RPP may be identified by an index. If a time domain index is used, the time-domain index may be relative to the RPP. The SL-PRS resources to be used by the remote UE 602A may include all or a portion of the SL-PRS resources within the reserved RPP.

In the example illustrated in FIG. 9, the relay UE 600A sends the reservation message, but alternatively, the remote UE 602A may send the reservation message.

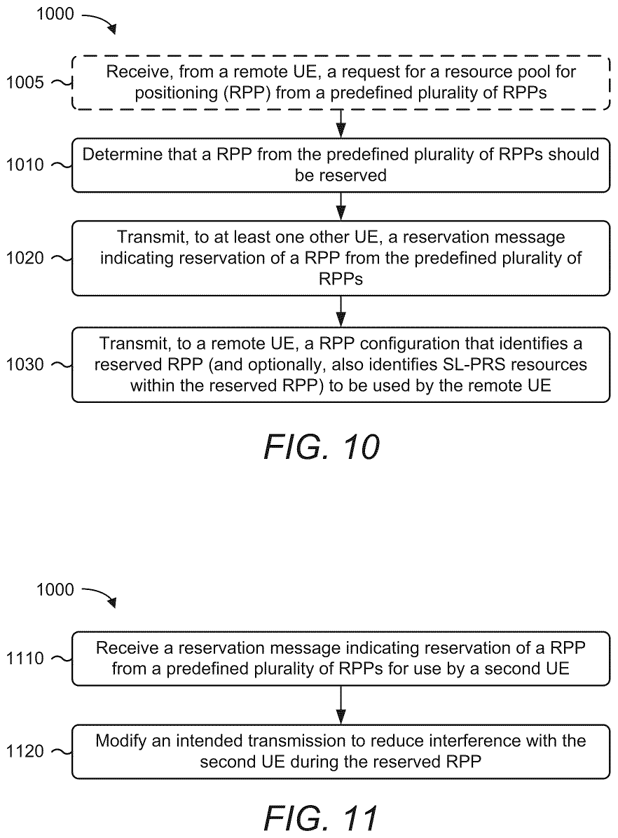

FIG. 10 is a flowchart of an example process 1000 associated with coordinated reservation of sidelink resource pools for positioning. In some implementations, one or more process blocks of FIG. 10 may be performed by a UE (e.g., UE 500, UE 600, UE 602). In some implementations, one or more process blocks of FIG. 10 may be performed by another device or a group of devices separate from or including the UE. Additionally, or alternatively, one or more process blocks of FIG. 10 may be performed by one or more components of device 500, such as processing system 510, memory 514, transceiver 504, SPS receiver 506, sidelink manager 570, and user interface 550, any or all of which may be considered means for performing this operation.

As shown in FIG. 10, process 1000 may include determining that a resource pool for positioning (RPP) from a predefined plurality of RPPs should be reserved (block 1010). Means for performing the operation at block 1010 may include the processing system 554 of UE 502. For example, the UE 502 may determine that a resource pool for positioning (RPP) from a predefined plurality of RPPs should be reserved using the processing system 552, as described above. In some aspects, the predefined plurality of RPPs is preloaded on the UE. In some aspects, the predefined plurality of RPPs is configured by a serving base station. In some aspects, determining that a RPP from the predefined plurality of RPPs should be reserved comprises selecting an RPP from the predefined plurality of RPPs.

In some aspects, the operation at block 1010 may be performed by a relay UE in response to receiving, from a remote UE being served by the relay UE, a request for a RPP from the predefined plurality of RPPs (block 1005). Means for performing the operation at block 1005 may include the WWAN transceiver 510 and the processing system 554 of UE 502. For example, the UE 502 may receive, via the receiver(s) 512, the request from the remote UE, as described above. In some aspects, the request identifies a specific RPP from the predefined plurality of RPPs. In some aspects, the reservation message indicates reservation of the specific RPP identified in the request. In some aspects, the reservation message indicates reservation of an RPP different from the specific RPP identifies in the request.

As further shown in FIG. 10, process 1000 may include transmitting, to at least one other UE, a reservation message indicating reservation of a RPP from the predefined plurality of RPPs (block 1020). Means for performing the operation at block 1020 may include the WWAN transceiver 510 and the processing system 552 of the UE 502. For example, the UE 502 may transmit, via the transmitter(s) 514, the reservation message indicating reservation of a RPP from the predefined plurality of RPPs, as described above.

In some aspects, the reservation message is transmitted via a broadcast, groupcast, or multicast message. In some aspects, the reservation message is transmitted via a physical sidelink control channel (PSCCH), a physical sidelink shared channel (PSSCH), or a combination thereof. In some aspects, the reservation message indicates that a sidelink positioning reference signal (SL-PRS) will be transmitted using the reserved RPP. In some aspects, the reservation message identifies a remote UE that will use the reserved RPP. In some aspects, the reservation message comprises an RPP identifier. In some aspects, the reservation message comprises a zone identifier. In some aspects, the reservation message comprises a priority indication. In some aspects, the reservation message comprises timing information associated with the reservation. In some aspects, the timing information associated with the reservation comprises a start time of the RPP, a stop time of the RPP, a time offset of the RPP, a periodicity of the RPP, an indicator that the RPP does not repeat, or combinations thereof. In some aspects, the reservation message comprises a request that the at least one other UE reduce interference during the reserved RPP. In some aspects, reducing interference comprises rate-matching, muting, puncturing, reducing transmit power, or combinations thereof.

As further shown in FIG. 10, process 1000 may include transmitting, to a remote UE, a RPP configuration that identifies a reserved RPP, e.g., when process 1000 is being performed by a relay UE (block 1030). Means for performing the operation at block 1030 may include the WWAN transceiver 510 and the processing system 552 of the UE 502. For example, the UE 502 may transmit, via the transmitter(s) 514, the RPP configuration that identifies the reserved RPP, as described above. In some aspects, the RPP configuration may identify specific SL-PRS resources within the reserved RPP to be used by the remote UE. In some aspects, the SL-PRS resources within the reserved RPP are identified by an index. In some aspects, the identified SL-PRS resources comprise all or a portion of the SL-PRS resources within the reserved RPP.

Process 1000 may include additional implementations, such as any single implementation or any combination of implementations described below and/or in connection with one or more other processes described elsewhere herein.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a flowchart of an example process 1100 associated with coordinated reservation of sidelink resource pools for positioning. In some implementations, one or more process blocks of FIG. 11 may be performed by a UE (e.g., UE 500, UE 600, UE 602). In some implementations, one or more process blocks of FIG. 11 may be performed by another device or a group of devices separate from or including the user equipment (UE). Additionally, or alternatively, one or more process blocks of FIG. 11 may be performed by one or more components of device 500, such as processing system 510, memory 514, transceiver 504, SPS receiver 506, sidelink manager 570, and user interface 550, any or all of which may be considered means for performing this operation.

As shown in FIG. 11, process 1100 may include receiving a reservation message indicating reservation of a RPP from a predefined plurality of RPPs for use by a second UE (block 1110). Means for performing the operation at block 1110 may include the WWAN transceiver 512 and the processing system 552 of the UE 502. For example, the UE 502 may receive, via the receiver(s) 512, the reservation message indicating reservation of a RPP from a predefined plurality of RPPs for use by a second UE, as described above.

In some aspects, the predefined plurality of RPPs is preloaded. In some aspects, the predefined plurality of RPPs is configured by a serving base station. In some aspects, the reservation message is received via a broadcast, groupcast, or multicast message. In some aspects, the reservation message is received via a PSCCH, a PSSCH, or a combination thereof. In some aspects, the reservation message indicates that a SL-PRS will be transmitted using the reserved RPP. In some aspects, the reservation message identifies the second UE that will use the reserved RPP. In some aspects, the reservation message comprises an RPP identifier. In some aspects, the reservation message comprises a zone identifier. In some aspects, the reservation message comprises a priority indication. In some aspects, the reservation message comprises timing information associated with the reservation. In some aspects, the timing information associated with the reservation comprises a start time of the RPP, a stop time of the RPP, a time offset of the RPP, a periodicity of the RPP, an indicator that the RPP does not repeat, or combinations thereof. In some aspects, the reservation message identifies sidelink positioning reference signal (SL-PRS) resources within the reserved RPP. In some aspects, the SL-PRS resources within the reserved RPP are identified by an index. In some aspects, the identified SL-PRS resources comprise all or a portion of the SL-PRS resources within the reserved RPP.

As further shown in FIG. 11, process 1100 may include modifying an intended transmission to reduce interference with the second UE during the reserved RPP (block 1120). Means for performing the operation at block 1120 may include the WWAN transceiver 512 and the processing system 552 of the UE 502. For example, the processing system 552 of the UE 502 may modify an intended transmission by the transmitter(s) 514 to reduce interference with the second UE during the reserved RPP, as described above. In some aspects, modifying the intended transmission comprises rate-matching, muting, puncturing, reducing transmit power, or combinations thereof

Process 1100 may include additional implementations, such as any single implementation or any combination of implementations described below and/or in connection with one or more other processes described elsewhere herein.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Aspect Examples are Described in the Following Numbered Clauses:
Clause 1. A method of wireless communication performed by a user equipment (UE), the method comprising: determining that a resource pool for positioning (RPP) from a predefined plurality of RPPs should be reserved; and transmitting, to at least one other UE, a reservation message indicating reservation of a RPP from the predefined plurality of RPPs.
Clause 2. The method of clause 1, where the predefined plurality of RPPs is preloaded.
Clause 3. The method of any of clauses 1 to 2, wherein the predefined plurality of RPPs is configured by a serving base station.
Clause 4. The method of any of clauses 1 to 3, wherein determining that a RPP from the predefined plurality of RPPs should be reserved comprises selecting an RPP from the predefined plurality of RPPs.
Clause 5. The method of any of clauses 1 to 4, wherein the reservation message is transmitted via a broadcast, groupcast, or multicast message.
Clause 6. The method of any of clauses 1 to 5, wherein the reservation message is transmitted via a physical sidelink control channel (PSCCH), a physical sidelink shared channel (PSSCH), or a combination thereof.
Clause 7. The method of any of clauses 1 to 6, wherein the reservation message indicates that a sidelink positioning reference signal (SL-PRS) will be transmitted using the reserved RPP.
Clause 8. The method of any of clauses 1 to 7, wherein the reservation message identifies a remote UE that will use the reserved RPP.
Clause 9. The method of any of clauses 1 to 8, wherein the reservation message comprises an RPP identifier.
Clause 10. The method of any of clauses 1 to 9, wherein the reservation message comprises a zone identifier.
Clause 11. The method of any of clauses 1 to 10, wherein the reservation message comprises a priority indication.
Clause 12. The method of any of clauses 1 to 11, wherein the reservation message comprises timing information associated with the reservation.
Clause 13. The method of clause 12, wherein the timing information associated with the reservation comprises a start time of the RPP, a stop time of the RPP, a time offset of the RPP, a periodicity of the RPP, an indicator that the RPP does not repeat, or combinations thereof.
Clause 14. The method of any of clauses 1 to 13, wherein the reservation message comprises a request that the at least one other UE reduce interference during the reserved RPP.
Clause 15. The method of clause 14, wherein reducing interference comprises rate-matching, muting, puncturing, reducing transmit power, or combinations thereof.
Clause 16. The method of any of clauses 1 to 15, wherein the UE comprises a relay UE that is associated with a remote UE.
Clause 17. The method of clause 16, further comprising: receiving, from the remote UE, a request for a RPP from the predefined plurality of RPPs, wherein determining that a RPP from the predefined plurality of RPPs is based on receiving the request.
Clause 18. The method of clause 17, wherein the request identifies a specific RPP from the predefined plurality of RPPs.
Clause 19. The method of clause 18, wherein the reservation message indicates reservation of the specific RPP identified in the request.
Clause 20. The method of any of clauses 18 to 19, wherein the reservation message indicates reservation of an RPP different from the specific RPP identified in the request.
Clause 21. The method of any of clauses 16 to 20, further comprising: transmitting, to the remote UE, a RPP configuration that identifies the reserved RPP to be used by the remote UE.
Clause 22. The method of clause 21, wherein the RPP configuration identifies sidelink positioning reference signal (SL-PRS) resources within the reserved RPP.
Clause 23. The method of clause 22, wherein the SL-PRS resources within the reserved RPP are identified by an index.
Clause 24. The method of any of clauses 22 to 23, wherein the identified SL-PRS resources comprise all or a portion of the SL-PRS resources within the reserved RPP.
Clause 25. A method of wireless communication performed by a user equipment (UE), the method comprising: receiving a reservation message indicating reservation of a RPP from a predefined plurality of RPPs for use by a second UE; and modifying an intended transmission to reduce interference with the second UE during the reserved RPP.
Clause 26. The method of clause 25, wherein modifying the intended transmission comprises rate-matching, muting, puncturing, reducing transmit power, or combinations thereof.
Clause 27. The method of any of clauses 25 to 26, where the predefined plurality of RPPs is preloaded.
Clause 28. The method of any of clauses 25 to 27, wherein the predefined plurality of RPPs is configured by a serving base station.
Clause 29. The method of any of clauses 25 to 28, wherein the reservation message is received via a broadcast, groupcast, or multicast message.
Clause 30. The method of any of clauses 25 to 29, wherein the reservation message is received via a physical sidelink control channel (PSCCH), a physical sidelink shared channel (PSSCH), or a combination thereof.
Clause 31. The method of any of clauses 25 to 30, wherein the reservation message indicates that a sidelink positioning reference signal (SL-PRS) will be transmitted using the reserved RPP.
Clause 32. The method of any of clauses 25 to 31, wherein the reservation message identifies the second UE that will use the reserved RPP.
Clause 33. The method of any of clauses 25 to 32, wherein the reservation message comprises an RPP identifier.
Clause 34. The method of any of clauses 25 to 33, wherein the reservation message comprises a zone identifier.
Clause 35. The method of any of clauses 25 to 34, wherein the reservation message comprises a priority indication.
Clause 36. The method of any of clauses 25 to 35, wherein the reservation message comprises timing information associated with the reservation.
Clause 37. The method of clause 36, wherein the timing information associated with the reservation comprises a start time of the RPP, a stop time of the RPP, a time offset of the RPP, a periodicity of the RPP, an indicator that the RPP does not repeat, or combinations thereof.
Clause 38. The method of any of clauses 25 to 37, wherein the reservation message identifies sidelink positioning reference signal (SL-PRS) resources within the reserved RPP.
Clause 39. The method of clause 38, wherein the SL-PRS resources within the reserved RPP are identified by an index.
Clause 40. The method of any of clauses 38 to 39, wherein the identified SL-PRS resources comprise all or a portion of the SL-PRS resources within the reserved RPP.
Clause 41. A user equipment (UE), comprising: a memory; at least one transceiver; and at least one processor communicatively coupled to the memory and the at least one transceiver, the at least one processor configured to: determine that a resource pool for positioning (RPP) from a predefined plurality of RPPs should be reserved; and cause the at least one transceiver to transmit, to at least one other UE, a reservation message indicating a reservation of a RPP from the predefined plurality of RPPs.
Clause 42. The UE of clause 41, where the predefined plurality of RPPs is preloaded.
Clause 43. The UE of any of clauses 41 to 42, wherein the predefined plurality of RPPs is configured by a serving base station.
Clause 44. The UE of any of clauses 41 to 43, wherein, to determine that a RPP from the predefined plurality of RPPs should be reserved, the processor is configured to select an RPP from the predefined plurality of RPPs.
Clause 45. The UE of any of clauses 41 to 44, wherein the reservation message is transmitted via a broadcast, groupcast, or multicast message.
Clause 46. The UE of any of clauses 41 to 45, wherein the reservation message is transmitted via a physical sidelink control channel (PSCCH), a physical sidelink shared channel (PSSCH), or a combination thereof.
Clause 47. The UE of any of clauses 41 to 46, wherein the reservation message indicates that a sidelink positioning reference signal (SL-PRS) will be transmitted using the reserved RPP.
Clause 48. The UE of any of clauses 41 to 47, wherein the reservation message identifies a remote UE that will use the reserved RPP.
Clause 49. The UE of any of clauses 41 to 48, wherein the reservation message comprises an RPP identifier.
Clause 50. The UE of any of clauses 41 to 49, wherein the reservation message comprises a zone identifier.
Clause 51. The UE of any of clauses 41 to 50, wherein the reservation message comprises a priority indication.
Clause 52. The UE of any of clauses 41 to 51, wherein the reservation message comprises timing information associated with the reservation of the RPP.
Clause 53. The UE of clause 52, wherein the timing information associated with the reservation of the RPP comprises a start time of the RPP, a stop time of the RPP, a time offset of the RPP, a periodicity of the RPP, an indicator that the RPP does not repeat, or combinations thereof.
Clause 54. The UE of any of clauses 41 to 53, wherein the reservation message comprises a request that the at least one other UE reduce interference during the reserved RPP.
Clause 55. The UE of clause 54, wherein the at least one processor being configured to reduce interference comprises the at least one processor being configured to rate-matching, muting, puncturing, reducing transmit power, or combinations thereof.
Clause 56. The UE of any of clauses 41 to 55, wherein the UE comprises a relay UE that is associated with a remote UE.
Clause 57. The UE of clause 56, wherein the at least one processor is further configured to receive, from the remote UE, a request for a RPP from the predefined plurality of RPPs, wherein determining that a RPP from the predefined plurality of RPPs should be reserved is based on receiving the request.
Clause 58. The UE of clause 57, wherein the request identifies a specific RPP from the predefined plurality of RPPs.
Clause 59. The UE of clause 58, wherein the reservation message indicates reservation of the specific RPP identified in the request.
Clause 60. The UE of any of clauses 58 to 59, wherein the reservation message indicates reservation of an RPP different from the specific RPP identified in the request.
Clause 61. The UE of any of clauses 56 to 60, wherein the at least one processor is further configured to: cause the at least one transceiver to transmit, to the remote UE, a RPP configuration that identifies the reserved RPP to be used by the remote UE.
Clause 62. The UE of clause 61, wherein the RPP configuration identifies sidelink positioning reference signal (SL-PRS) resources within the reserved RPP.
Clause 63. The UE of clause 62, wherein the SL-PRS resources within the reserved RPP are identified by an index.
Clause 64. The UE of any of clauses 62 to 63, wherein the identified SL-PRS resources comprise all or a portion of the SL-PRS resources within the reserved RPP.
Clause 65. A user equipment (UE), comprising: a memory; at least one transceiver; and at least one processor communicatively coupled to the memory and the at least one transceiver, the at least one processor configured to: receive a reservation message indicating reservation of a RPP from a predefined plurality of RPPs for use by a second UE; and modify an intended transmission to reduce interference with the second UE during the reserved RPP.
Clause 66. The UE of clause 65, wherein the at least one processor being configured to modify the intended transmission comprises the at least one processor being configured to rate-match, mute, puncture, reduce transmit power, or combinations thereof.
Clause 67. The UE of any of clauses 65 to 66, where the predefined plurality of RPPs is preloaded.
Clause 68. The UE of any of clauses 65 to 67, wherein the predefined plurality of RPPs is configured by a serving base station.
Clause 69. The UE of any of clauses 65 to 68, wherein the reservation message is received via a broadcast, groupcast, or multicast message.
Clause 70. The UE of any of clauses 65 to 69, wherein the reservation message is received via a physical sidelink control channel (PSCCH), a physical sidelink shared channel (PSSCH), or a combination thereof.
Clause 71. The UE of any of clauses 65 to 70, wherein the reservation message indicates that a sidelink positioning reference signal (SL-PRS) will be transmitted using the reserved RPP.
Clause 72. The UE of any of clauses 65 to 71, wherein the reservation message identifies the second UE that will use the reserved RPP.
Clause 73. The UE of any of clauses 65 to 72, wherein the reservation message comprises an RPP identifier.
Clause 74. The UE of any of clauses 65 to 73, wherein the reservation message comprises a zone identifier.
Clause 75. The UE of any of clauses 65 to 74, wherein the reservation message comprises a priority indication.
Clause 76. The UE of any of clauses 65 to 75, wherein the reservation message comprises timing information associated with the reservation of the RPP.
Clause 77. The UE of clause 76, wherein the timing information associated with the reservation of the RPP comprises a start time of the RPP, a stop time of the RPP, a time offset of the RPP, a periodicity of the RPP, an indicator that the RPP does not repeat, or combinations thereof.
Clause 78. The UE of any of clauses 65 to 77, wherein the reservation message identifies sidelink positioning reference signal (SL-PRS) resources within the reserved RPP.
Clause 79. The UE of clause 78, wherein the SL-PRS resources within the reserved RPP are identified by an index.
Clause 80. The UE of any of clauses 78 to 79, wherein the identified SL-PRS resources comprise all or a portion of the SL-PRS resources within the reserved RPP.
Clause 81. An apparatus comprising a memory and at least one processor communicatively coupled to the memory, the memory and the at least one processor configured to perform a method according to any of clauses 1 to 80.
Clause 82. An apparatus comprising means for performing a method according to any of clauses 1 to 80.
Clause 83. A non-transitory computer-readable medium storing computer-executable instructions, the computer-executable comprising at least one instruction for causing a computer or processor to perform a method according to any of clauses 1 to 80.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

A complete listing of the claims, including current amendments (if any), is as follows:

1. A method of wireless communication performed by a user equipment (UE), the method comprising:
determining that a resource pool for positioning (RPP) from a predefined plurality of RPPs should be reserved; and
transmitting, to at least one other UE, a reservation message indicating reservation of a RPP from the predefined plurality of RPPs.

2. The method of claim 1, where the predefined plurality of RPPs is preloaded or configured by a serving base station.

3. (canceled)

4. (canceled)

5. The method of claim 1, wherein the reservation message is transmitted via a broadcast, groupcast, or multicast message over a physical sidelink control channel (PSCCH), a physical sidelink shared channel (PSSCH), or a combination thereof.

6. (canceled)

7. The method of claim 1, wherein the reservation message indicates that a sidelink positioning reference signal (SL-PRS) will be transmitted using the reserved RPP.

8. The method of claim 1, wherein the reservation message identifies a remote UE that will use the reserved RPP.

9. The method of claim 1, wherein the reservation message comprises at least one of an RPP identifier, a zone identifier, a priority indication, or timing information associated with the reservation.

10. (canceled)

11. (canceled)

12. (canceled)

13. (canceled)

14. The method of claim 1, wherein the reservation message comprises a request that the at least one other UE reduce interference during the reserved RPP via rate-matching, muting, puncturing, reducing transmit power, or combinations thereof.

15. (canceled)

16. The method of claim 1, wherein the UE comprises a relay UE that is associated with a remote UE.

17. The method of claim 16, further comprising:
receiving, from the remote UE, a request for a RPP from the predefined plurality of RPPs, wherein determining that a RPP from the predefined plurality of RPPs is based on receiving the request.

18. The method of claim 17, wherein the request at least one of identifies a specific RPP from the predefined plurality of RPPs, indicates reservation of the specific RPP identified in the request, or indicates reservation of an RPP different from the specific RPP identified in the request.

19. (canceled)

20. (canceled)

21. The method of claim 16, further comprising:
transmitting, to the remote UE, a RPP configuration that identifies the reserved RPP to be used by the remote UE.

22. The method of claim 21, wherein the RPP configuration identifies sidelink positioning reference signal (SL-PRS) resources within the reserved RPP.

23. (canceled)

24. (canceled)

25. A method of wireless communication performed by a user equipment (UE), the method comprising:
receiving a reservation message indicating reservation of a RPP from a predefined plurality of RPPs for use by a second UE; and
modifying an intended transmission to reduce interference with the second UE during the reserved RPP.

26. The method of claim 25, wherein modifying the intended transmission comprises rate-matching, muting, puncturing, reducing transmit power, or combinations thereof.

27. The method of claim 25, where the predefined plurality of RPPs is preloaded or is configured by a serving base station.

28. (canceled)

29. The method of claim 25, wherein the reservation message is received via a broadcast, groupcast, or multicast message over a physical sidelink control channel (PSCCH), a physical sidelink shared channel (PSSCH), or a combination thereof.

30. (canceled)

31. The method of claim 25, wherein the reservation message indicates that a sidelink positioning reference signal (SL-PRS) will be transmitted using the reserved RPP.

32. The method of claim 25, wherein the reservation message identifies the second UE that will use the reserved RPP.

33. The method of claim 25, wherein the reservation message comprises at least one of an RPP identifier, a zone identifier, a priority indication, or timing information associated with the reservation.

34. (canceled)

35. (canceled)

36. (canceled)

37. (canceled)

38. The method of claim 25, wherein the reservation message identifies sidelink positioning reference signal (SL-PRS) resources within the reserved RPP.

39. (canceled)

40. (canceled)

41. A user equipment (UE), comprising:
a memory;
at least one transceiver; and
at least one processor communicatively coupled to the memory and the at least one transceiver, the at least one processor configured to:
determine that a resource pool for positioning (RPP) from a predefined plurality of RPPs should be reserved; and
cause the at least one transceiver to transmit, to at least one other UE, a reservation message indicating a reservation of a RPP from the predefined plurality of RPPs.

42. The UE of claim 41, where the predefined plurality of RPPs is preloaded or configured by a serving base station.

43. (canceled)

44. (canceled)

45. The UE of claim 41, wherein the reservation message is transmitted via a broadcast, groupcast, or multicast message over a physical sidelink control channel (PSCCH), a physical sidelink shared channel (PSSCH), or a combination thereof.

46. (canceled)

47. The UE of claim 41, wherein the reservation message indicates that a sidelink positioning reference signal (SL-PRS) will be transmitted using the reserved RPP.

48. The UE of claim 41, wherein the reservation message identifies a remote UE that will use the reserved RPP.

49. The UE of claim 41, wherein the reservation message comprises at least one of an RPP identifier, a zone identifier, a priority indication, or timing information associated with the reservation.

50. (canceled)

51. (canceled)

52. (canceled)

53. (canceled)

54. The UE of claim 41, wherein the reservation message comprises a request that the at least one other UE reduce interference during the reserved RPP via rate-matching, muting, puncturing, reducing transmit power, or combinations thereof.

55. (canceled)

56. The UE of claim 41, wherein the UE comprises a relay UE that is associated with a remote UE.

57. The UE of claim 56, wherein the at least one processor is further configured to receive, from the remote UE, a request for a RPP from the predefined plurality of RPPs, wherein the at least one processor is further configured to determine that a RPP from the predefined plurality of RPPs should be reserved based on receiving the request.

58. The UE of claim 57, wherein the request at least one of identifies a specific RPP from the predefined plurality of RPPs, indicates reservation of the specific RPP identified in the request, or indicates reservation of an RPP different from the specific RPP identified in the request.

59. (canceled)

60. (canceled)

61. The UE of claim 56, wherein the at least one processor is further configured to:
cause the at least one transceiver to transmit, to the remote UE, a RPP configuration that identifies the reserved RPP to be used by the remote UE.

62. The UE of claim 61, wherein the RPP configuration identifies sidelink positioning reference signal (SL-PRS) resources within the reserved RPP.

63. (canceled)

64. (canceled)

65. A user equipment (UE), comprising:
a memory;
at least one transceiver; and
at least one processor communicatively coupled to the memory and the at least one transceiver, the at least one processor configured to:
receive a reservation message indicating reservation of a RPP from a predefined plurality of RPPs for use by a second UE; and
modify an intended transmission to reduce interference with the second UE during the reserved RPP.

66. The UE of claim 65, wherein the at least one processor being configured to modify the intended transmission comprises the at least one processor being configured to rate-match, mute, puncture, reduce transmit power, or combinations thereof.

67. The UE of claim 65, where the predefined plurality of RPPs is preloaded or is configured by a serving base station.

68. (canceled)

69. The UE of claim 65, wherein the reservation message is received via a broadcast, groupcast, or multicast message over a physical sidelink control channel (PSCCH), a physical sidelink shared channel (PSSCH), or a combination thereof.

70. (canceled)

71. The UE of claim 65, wherein the reservation message indicates that a sidelink positioning reference signal (SL-PRS) will be transmitted using the reserved RPP.

72. The UE of claim 65, wherein the reservation message identifies the second UE that will use the reserved RPP.

73. The UE of claim 65, wherein the reservation message comprises at least one of an RPP identifier, a zone identifier, a priority indication, or timing information associated with the reservation.

74. (canceled)

75. (canceled)

76. (canceled)

77. (canceled)

78. The UE of claim 65, wherein the reservation message identifies sidelink positioning reference signal (SL-PRS) resources within the reserved RPP.

79. (canceled)

80. (canceled)
